(19) United States
(12) Patent Application Publication
(10) Pub. No.: US 2009/0012680 A1
(43) Pub. Date: Jan. 8, 2009

(54) Method for Optimizing the Operating Mode of a Hydrodynamic Component Integrated in a Drive Train of a Vehicle

(76) Inventors: Markus Kley, Ellwangen (DE); Dieter Laukemann, Vellberg (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/664,451

(22) PCT Filed: Sep. 21, 2005
(86) PCT No.: PCT/EP05/10178

§ 371 Date: Jan. 23, 2008

(30) Foreign Application Priority Data
Oct. 2, 2004 (DE) 10 2004 048 120.2

(51) Int. Cl. F02D 45/00

(52) U.S. Cl. 701/51

(57) ABSTRACT

A method for optimizing the operating mode of a hydrodynamic component integrated into a drive train of a vehicle, using a regulating or control device associated with the component. A set characteristic curve or a set characteristic diagram is stored in a memory unit for a hydrodynamic component; an actual value of at least one variable at least indirectly characterizing an operating point is determined for each transmission process; and the actual value is compared with the set value from the set characteristic diagram. If the actual value deviates from the set value, the manipulated variable for the operating point in question is modified and stored as a new set manipulated variable for said operating point.

The invention concerns a method for optimizing the operating mode of a hydrodynamic component integrated in a drive train of a vehicle, in particular, for optimizing the transmissible torque or the available braking torque, in detail with the features from the preamble of claim 1; further, a method for optimizing the utilization of the available braking torque, in detail with the features from the preamble of claim 2.

In addition to hydraulic or mechanical systems, hydrodynamic retarders frequently find use as braking devices in vehicles. These are integrated at any site in the drive train either as an additional braking device or as the principal braking device. In the transmission of power from the driving machine to the wheels, the retarder can be arranged in front of the gearbox, in the gearbox or behind the gearbox. A specific characteristic diagram is assigned to the hydrodynamic retarder by the manufacturer, a diagram which was prepared, for example, in the final testing as a rigid actual characteristic diagram and a corresponding manipulated variable is assigned to each operating point in this characteristic diagram, as a function of what the driver wants, after a specific deceleration or generation of a specific braking power. As a rule, a control pressure functions as the manipulated variable. Depending on the selected working medium and the structure of the supply system for the working medium that results from it, as well as the triggering possibilities, the control pressure may correspond either to a static pressure that can be introduced on a resting level of working medium, a regulating pressure for the actuation of a valve device or else, in particular, in the design as a water pump retarder, may correspond to pressures for the control of the inlet and outlet cross sections or the differential pressures to and from the hydrodynamic retarder resulting therefrom. Depending on these pre-given set characteristic diagrams and the manipulated variables assigned to the individual operating points, as well as the wishes of the driver, a corresponding arrangement and triggering of the regulating device of the hydrodynamic retarder is provided. It has been shown, however, that during the operation of the vehicle, with the use of these rigid characteristic diagrams and the rigid assignment between the manipulated variables and the individual operating points assigned to them, the full braking power is frequently not exhausted; in particular, the hydrodynamic retarder does not produce the maximum braking power available to it in the corresponding operating points. In the individual case, this means longer braking paths and when used as the continuously operating brake due to the increased requirement for braking power over longer periods of time for achieving the desired result, a corresponding provision of cooling capacities, marginal conditions, which result from the incorporation, mounting, as well as other particular features during operation, cannot be taken into consideration also, due to the rigid advance setting of the characteristic diagrams.

The same type of problem applies analogously also for hydrodynamic couplings and hydrodynamic rpm/torque converters, in which the torque that can actually be transmitted in the case of structural units of the same type and the same marginal conditions can vary very greatly due to manufacturing tolerances. This leads frequently to the circumstance that the theoretically full transmissible torque is not actually available and thus either the hydrodynamic components are dimensioned correspondingly larger from the outset or else measures of a structural nature can be carried out subsequently for compensation.

Refer to the following documents for the written prior art:
DE 196 45 443 A1
WO 00/55520 A
EP 1 380 485 A

The object of the invention is thus to develop a method for optimizing the utilization of the transmissible power that is theoretically available, in particular, the torque in a vehicle with a drive train, comprising a driving machine and a hydrodynamic component with a regulating device assigned to it in such a way that the full theoretically transmissible torque in an operating point of a set characteristic diagram is also utilized and transmitted as much as possible, and overdimensionings are thus avoided. In particular, in hydrodynamic retarders, the full braking power that is theoretically available with a retarder of a specific size with a pre-given filling will be utilized without additional structural measures.

The solution according to the invention is characterized by the features of claims 1 and 2. Advantageous configurations are presented in the subclaims.

According to the invention, the scattering of values caused by tolerances or other marginal conditions that occur during the operation of the hydrodynamic component, in particular, the coupling, converter, or the hydrodynamic retarder in a drive train, in particular the drive train of a vehicle in which the actual characteristic curve or actual characteristic diagram describing the transmission behavior, which is achievable by means of a hydrodynamic component, is minimized in this way and thus the actual values are adapted to the set characteristic curve or set characteristic diagrams describing the theoretically possible transmission behavior such that the actual values that are adjusted lie at least in a pre-defined tolerance range of the set characteristic curve or of the set characteristic diagram of the variables describing the operating mode at least indirectly, and preferably correspond directly to these, by adjusting the manipulated variable, in particular, adapting it. A hydrodynamic retarder thus involves the actual characteristic curve or actual characteristic diagram describing this and obtainable with this in a braking process, this curve or diagram characterizing the operating mode of the hydrodynamic retarder at least indirectly. In this way, the actual characteristic curve is adapted to the set characteristic curves or a set characteristic diagram that can be theoretically obtained with the retarder of a specific type, by adapting the manipulated variable such that the actual values that are adjusted lie at least in the tolerance range of the set characteristic curve or of the set characteristic diagram of the variables describing the operating mode of the hydrodynamic retarder at least indirectly, and preferably correspond directly to these, The actual characteristic curve or the actual characteristic diagram contains the variables characterizing at least indirectly the operating mode of the hydrodynamic component—hydrodynamic coupling, converter or hydrodynamic retarder. This is solved by the fact that in general a theoretical set characteristic curve or a set characteristic diagram for a hydrodynamic component of a specific type is filed in a memory storage unit, wherein a set manipulated variable is assigned to each operating point of the set characteristic curve or the set characteristic diagram for adjusting it. Depending on an advance setting according to a torque to be transmitted, a power or a variable describing this at least indirectly or an advance setting after producing a specific braking torque, a desired deceleration or another variable characterizing the braking process, for example, a braking path, etc., the regulating device is actuated with the set manipulated variable that is pre-given for adjusting the desired operating point. This preferably applies to the entire transmission or braking process, i.e., for example, to the braking process for the building up of the braking torque over the time period of the braking process or the change in the rpm of the element to be braked. For this purpose, the variables characterizing these variables at least indirectly are determined and compared with the corresponding variables of the respective operating point of the set characteristic curve or of the set characteristic diagram. If there is a deviation, the manipulated variable for the adjustment for influencing at least indirectly the actual values of the parameters characterizing the individual operating points is changed for the respective operating point. The modified set manipulated variable is stored as a new set manipulated variable for the respective operating point, in the case of a desired repeated adjusting of the respective operating point this value being used as the set manipulated variable for actuating the regulating device for influencing the transmission behavior, in particular the torque and in retarders, the braking torque.

The solution according to the invention is used both in driving operation as well as in the final testing of the vehicle on a test stand, in particular a roller-type test stand. For the retarder, the latter is then braked against the engine.

The solution according to the invention makes it possible, even with larger structural parts and installation tolerances as well as different marginal conditions with the same requirements to transmit essentially at all times the same torque or to provide the same braking power. This is accomplished very simply by the corresponding calibration of the characteristic diagram, in particular, the characteristic diagram of the manipulated variables. An improvement of the matching between the control variables and the initial values is achieved in this way. The new set manipulated variables are then filed in an at least writable and readable memory for the individual operating points of a corresponding characteristic diagram or a characteristic curve. In the simplest case, this filing is provided in a memory storage unit for properties, which is assigned to the hydrodynamic component, in particular, the hydrodynamic coupling, converter or hydrodynamic retarder, whereby the latter can be disposed preferably on the housing of the hydrodynamic component or at a short spatial distance from it. The property storage device itself can store, in addition to the storage of characteristic curves, but preferably of characteristic diagrams, in particular, the characteristic diagram of manipulated variables and the set characteristic diagram for the operating mode of the retarder, still other variables describing the operating mode and/or the functioning of the hydrodynamic retarder. For this purpose, corresponding inputs are assigned to this, which are coupled with corresponding recording devices. Preferably, at least one communications interface is provided, which makes possible the read-in of data into the property storage unit as well as its read-out. The property storage unit can be connected with a data communications network or a control device for this purpose. In this way, the set characteristic diagram or the set manipulated variables, when used in vehicles, are usually read out when the control device is first put into operation and then processed and adapted in this device. After adapting the characteristic curves or characteristic diagrams for the manipulated variables, a corresponding communication can also be made in turn to the property storage unit, so that, in particular, when the control device is changed, the set manipulated variable characteristic curve already adapted to the hydrodynamic retarder for obtaining the optimal characteristic curve is also made available to the new control. This means, taken in detail, that the corresponding actuating control curve always remains for the hydrodynamic component. However, this is not absolutely necessary. It is also conceivable to file the set characteristic curves for the individual characteristic curves as well as the set characteristic curves and the set characteristic diagrams for the manipulated variables in a control device and to process them as needed. The control device can thus be formed from a central control device, which is assigned to a multiple number of components of the drive train, or else is a separate control device assigned to the hydrodynamic component or to the unit containing this component. The latter may in turn be disposed on the housing of the unit or that of the hydrodynamic component or can even be disposed in this component. This control device then serves also for processing additional set and actual values during operation. In particular, in addition to the processing of the recorded actual values, the variables characterizing the operating mode of the hydrodynamic component at least indirectly are also recorded and processed in the control device.

The actual values, which are determined for each braking process, at least of one value characterizing the braking process, at least indirectly and preferably continuously, usually involve the braking torque or a variable describing it at least indirectly, whereby these variables are preferably determined by the change in the rpm of the element to be braked. Therefore, each time depending on the desired braking power, the braking torque can either be adjusted in steps or else continually adjusted. In the first-named case, the characteristic diagram is comprised of at least one characteristic curve, preferably a plurality of individual characteristic curves assigned to the individual braking steps, while in the other case, each operating point between a pre-given maximum and minimum curve for the course of the braking torque can be triggered via an rpm of the element to be braked, preferably the rpm of the rotor impeller, whereby a corresponding set manipulated variable is also assigned to each individual operating point in the characteristic diagram, and this will bring about the adjusting of this operating point. The individual braking torque is thus a function of the manipulated variable, in particular, the control pressure. This pressure determines the filling of the retarder.

This applies analogously also to hydrodynamic components in the form of couplings and converters. The variables characterizing the transmission behavior are thus recorded or determined over the entire time period of transmission, preferably continuously or in time intervals. The variables characterizing the transmission behavior involve, for example, the transmissible torque, the conversion or at least one variable describing these variables at least indirectly.

According to a further development of the invention, a specific tolerance range is always given in advance for the set characteristic diagram or a set characteristic curve, wherein the limiting values describing these diagrams or curves can either be defined in advance or else are established. The tolerance band, i.e., the deviation upward and/or downward at an operating point, thus preferably amounts to a maximum of 20% of the braking torque, when taking the braking torque as an example.

According to a particularly advantageous further development, a prognostic or forward-looking adaptation is optionally also offered. This means that the correction or adaptation of the operating points is additionally stored. For this purpose, for example, the adaptations provided with respect to the determined or obtained operating points are also stored. Trends for future adaptations can thus be derived from the different correction values and adaptations. Thus, for example, at a specific rpm n and temperature of the working medium, a specific regulating pressure was present as a manipulated variable in order to achieve a specific torque. Due to aging, in particular, cavitation of the circuit parts, increasing leakages in the circuit and thus a circuit pressure that is difficult to maintain, an adaptation of the regulating pressure is continually necessary over time. If the operating point is triggered after a longer period of time, the control pressure that is now to be used can be quasi-predicted based on a stored algorithm. This forward-looking adaptation is particularly meaningful for operating points that are seldom actuated. That is, a specific operating point should be adapted based on its history, in particular the change over time as well as the history of other operating points, primarily adjacent ones, in particular their changing behavior over time.

The actual variables are adapted to the set variable by determining a deviation of the actual variables that characterize the operating mode, preferably for a retarder in the case of an actual variables characterizing the braking torque in an operating point, from the theoretically adjustable braking torque in this operating point by the change in the manipulated variable, whereby this change can either be functional or else can be carried out by means of a correction value. This change is carried out in the next run though this operating point or else in each nth passage though the same desired operating point when a deviation occurs. This applies analogously also to the other possible hydrodynamic components—coupling, converter. Here, the variables characterizing the operating mode involve, for example, the torque.

According to an advantageous further development, additional dependences are also recorded in conjunction. Thus, for example, it is considered that the transmissible torque in the case of hydrodynamic couplings and converters and the braking torque in the case of hydrodynamic retarders are strongly dependent on the temperature. Therefore, the temperature is preferably also recorded in conjunction and there results at least a three-dimensional characteristic diagram, wherein the torque is plotted as a function of the manipulated variable in the form of the regulating pressure and the temperature. Also conceivable is the consideration of other dependences, so that the characteristic diagram for the variables characterizing the operating mode at least indirectly is always multidimensional.

When a correction value k is used, this may involve a fixed pre-given correction value, which is applied to the manipulated variable, or else a correction value that can be calculated or determined, wherein functional relationships can thus be considered. In the simplest case, the correction value is a fixed quantity, which, when there is a deviation relative to the currently used set value for adjusting the actual variables to be adjusted, is added or subtracted. According to a particularly advantageous configuration, a finely stepped scanning is possible in order to keep the correction value variable, by calculating it as a function of values determined between two sequential identical operating points with multiple runs through the same operating point. Thus, the manipulated variable Yₛₑₜ is determined, for example, from the product of the manipulated variable established in the last adjustment of the operating point and the quotient from the currently determined torque, for retarders, in particular, the actual braking moment and the determined actual braking moment for the adjustment of this operating point or for previous such adjustments. Then, if the operating parameters that can be obtained with the new value for the set variable, in particular, the corresponding actual values for the braking torque, still lie in the tolerance range of the set characteristic values, the determined set manipulated variable is set and stored as the new set manipulated variable for this operating point. In this way, any change in the set value can be stored.

The solution according to the invention will be explained in the following on the basis of figures. Therein, the following are shown in detail:

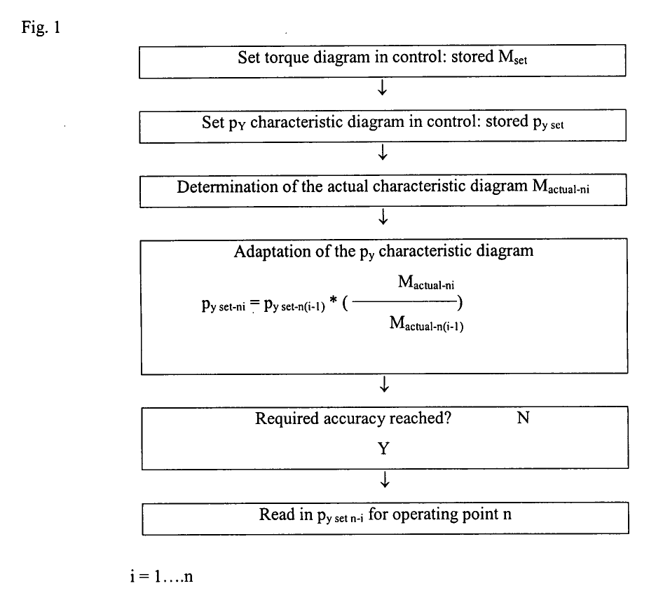

FIG. 1 illustrates in schematically simplified representation based on a signal flow diagram, a particularly advantageous embodiment of the method according to the invention;

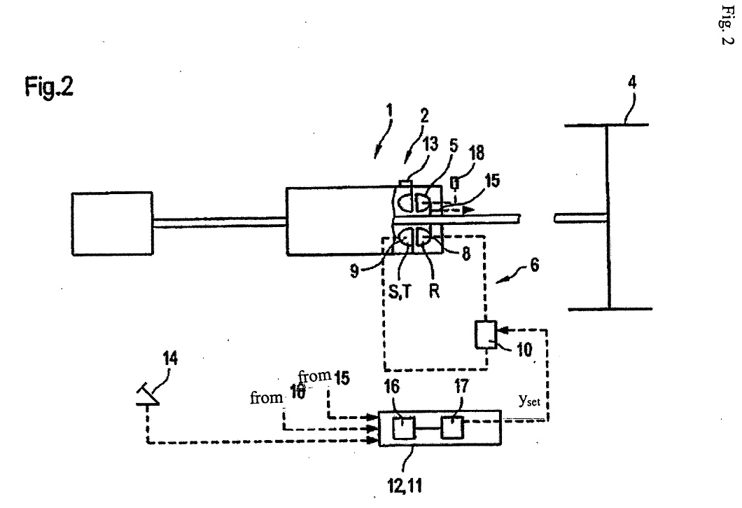

FIG. 2 illustrates in schematically simplified representation the basic structure and the arrangement of a hydrodynamic component in a drive train for implementing the method according to the invention;

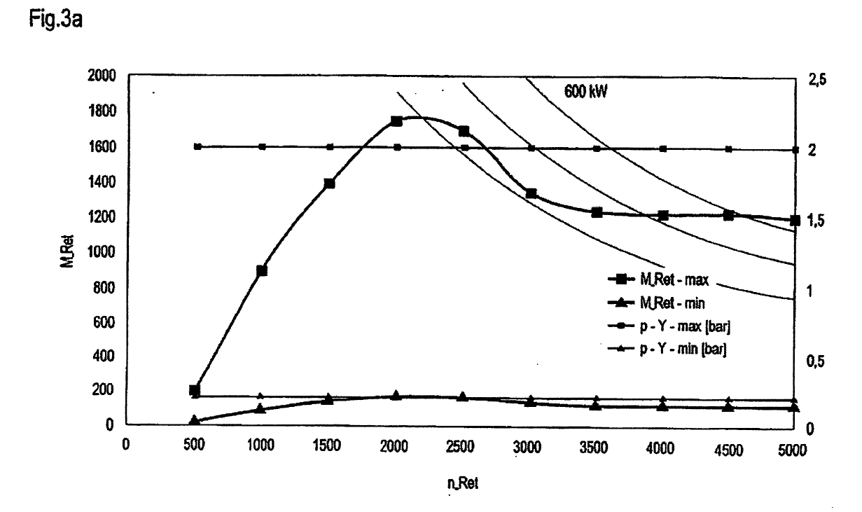

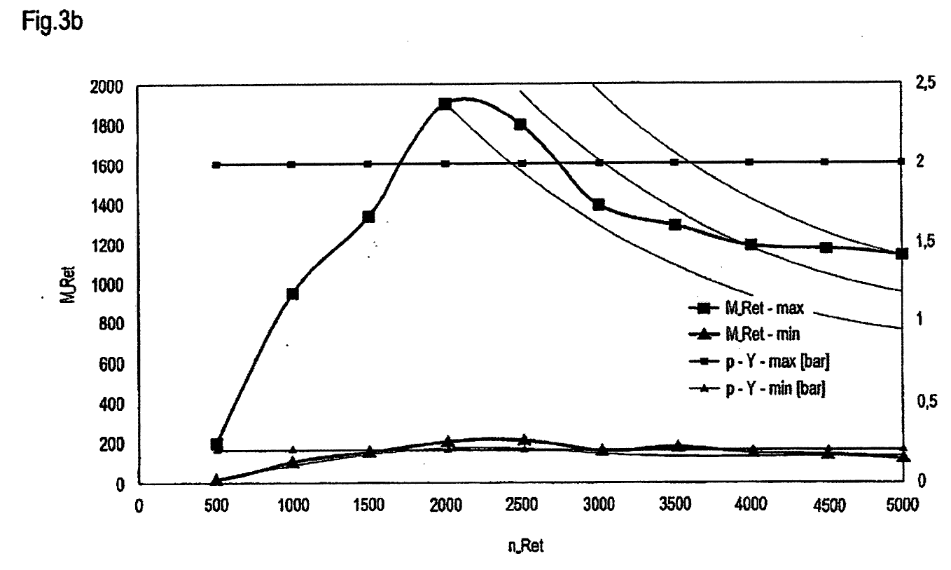

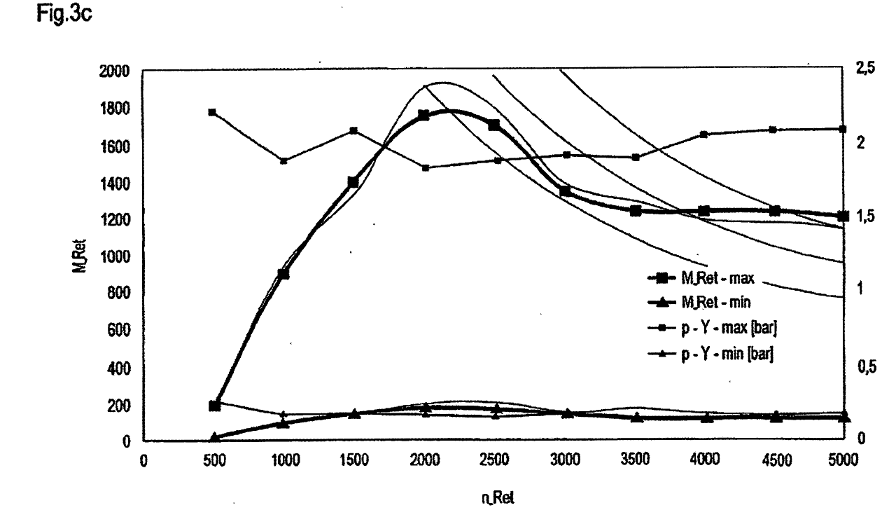

FIGS. 3a-3c thus illustrate the theoretical pre-given set characteristic diagram for a hydrodynamic retarder based on rpm/torque diagrams, the actual characteristic diagram determined during the operation run with deviations and the characteristic diagram for the hydrodynamic retarder that is corrected with the method according to the invention.

FIG. 1 illustrates in schematically simplified representation the basic course of a method according to the invention on the example of optimizing the provision of braking power in a vehicle 1, comprising a drive train 2 with a driving machine 3, which is coupled with the wheels 4 to be driven at least indirectly. A hydrodynamic component is disposed in drive train 2, in the case shown, of a hydrodynamic braking device 5, in the form of a hydrodynamic retarder. The drive train 2 is thus reproduced in FIG. 2 in schematically very simplified representation with respect to its functional interrelationships. The hydrodynamic component in the form of the retarder 5 comprises a primary impeller P functioning as a rotor blade wheel R and a secondary impeller T functioning as a stator blade wheel S. The secondary impeller T is thus stationary. A supply system 6 for working medium with at least one regulating device 10 is assigned to the retarder 5. Since the braking power of the hydrodynamic retarder 5 will usually be determined by the filling level present in the working chamber 7 and/or the pressure ratios in the individual lines of the supply system 6 for working medium, in particular, in at least one inlet 8 into the working chamber and/or one outlet 9 from the working chamber 7, a regulating device 10 is assigned to the braking device 5. This can be designed in different ways, each time according to the design and type of influencing of the transmissible braking torque as well as the design of the supply system 6 for working medium of the hydrodynamic retarder 5. For adjusting a braking torque M_{brake} characterizing the desired braking power, in the form of a pre-given set characteristic curve or a set characteristic diagram for the theoretically available and adjustable braking torque, an appropriate manipulated variable Y is assigned to the regulating device 10 for each individual operating point of the set characteristic diagram or the set characteristic curve. This is reproduced either in a set manipulated variable characteristic curve or else in a set manipulated variable characteristic diagram Yₛₑₜ with assignment to a corresponding operating point of the pre-defined or pre-given set characteristic curve for the adjustable braking torque of the hydrodynamic retarder 5. For each individual hydrodynamic retarder, in particular for models that are identical in structure and power, such pre-defined or pre-given set characteristic curves or characteristic diagrams exist. These usually involve rpm/torque characteristic diagrams, wherein here the rpm of the rotor blade wheel R or an element coupled with this at least indirectly, i.e., an element coupled directly or via additional transmission elements and gears is understood, and the braking torque M_{brake} that can be obtained with the hydrodynamic retarder 5. In order to obtain this set characteristic curve or the set characteristic diagram, a corresponding manipulated variable Yₛₑₜ₁ to Yₛₑₜₙ is thus assigned to each operating point, i.e., to each arbitrary rpm. The manipulated variable Yₛₑₜ is thus provided as a function of the currently present operating conditions via a control device 11, preferably in the form of a control instrument 12. The set characteristic curve or the set characteristic diagram for the manipulated variable Yₛₑₜ can thus be read out by the control device 11, each time according to assignment to the hydrodynamic retarder, also from a writable and readable memory 13 assigned to the hydrodynamic retarder 5 and introduced into control device 10. Then the function of the control device 11, in particular, that of the control instrument 12, can be taken over by any control device assigned, to components in the drive train when used in vehicles, or the central driving control. The setting in advance of a desired braking torque, a braking power or a desired deceleration or another variable describing the braking process at least indirectly that is to be adjusted is provided, therefore, by means of a device 14 for advance setting of the driver's wish for adjusting a braking torque or deceleration of the vehicle. Usually this device is designed in the form of a brake pedal or else of a brake step selector lever. In addition, recording devices are provided for recording a variable describing at least indirectly, the actual rpm n_{actual} of the primary impeller P, in particular of the rotor blade wheel R of the hydrodynamic retarder 5. This recording device is thus denoted 15 and can be assigned in the simplest case to the shaft joined with the rotor blade wheel R and is present in the form of a sensor, whereby this sensor generates a signal for the control device 11. The manipulated variable Yₛₑₜ is determined from the set characteristic curve for a specific operating state of the hydrodynamic retarder, which is filed in control device 11 corresponding to this signal, and is used to actuate control device 10. A specific torque value is thus adjusted at the hydrodynamic retarder 5, which is denoted M_{actual}, for this specific rpm n. This or a variable characterizing the latter at least indirectly, i.e., directly or via functioning relationships or proportionality is also recorded, for example, with a recording device 18 and is compared with the set characteristic diagram which is filed in control device 11 for the variables describing the operating mode at least indirectly. The actual value of the torque may also be calculated on different variables. Now, if a deviation exists, it is provided according to the invention to perform an adaptation of the manipulated variable Yₛₑₜ for this operating point and to then obtain by this means the pre-defined or pre-given set characteristic diagram or the individual characteristic curve for the torque that is to be adjusted. In this way, the manipulated variable Yₛₑₜ is changed for this operating point. This change can be produced in different ways. In the simplest case, an adaptation can be conducted here each time by a correction value, which is newly compensated each time with repeated adjusting of the operating point. Preferably, this procedure is selected for a multiple number of operating points, preferably at specific intervals, for example, rpm intervals or else selected for all operating points. In the last case, the entire operating range, which is determined, for example, by an rpm region, is run through each time. Another possibility consists of newly determining the manipulated variable in the form of a functional relationship. Several possibilities also exist in this respect. In the simplest case, therefore, the variables of the preceding runs through the operating region, which have already been determined without anything further, for the same operating points, i.e., the determined actual values, are used. This possibility is portrayed more precisely in FIG. 1. In the simplest case, this adaptation is thus also conducted in the control device 11. This still comprises for this purpose at least one comparison device 16 as well as a set value correction device 17. This process is repeated until the necessary accuracy is achieved. This can be provided, for example, by establishing in advance a tolerance band for a specified set characteristic curve that can describe the operating mode of the hydrodynamic component 1, whereby the initial process for attaining a value within the tolerance band for this operating point is interrupted. It is conceivable to place the tolerance band uniformly over the entire characteristic curve or else to permit greater deviations in individual regions. If the necessary accuracy is obtained, then the set value Y_{set-new} adapted each time for the individual operating points can be stored for the individual manipulated variables Y, whereby this characteristic diagram for set variables is then assigned to the hydrodynamic retarder 5 for the manipulated variable and can be used for any x control.

FIG. 1 illustrates the basic principle of the method according to the invention based on a signal flow diagram. For this purpose, for a specific type of hydrodynamic retarder, in particular, a retarder of specific structural type and structural size, a set characteristic diagram, which describes the operating mode of the hydrodynamic retarder 5, is filed in control device 11, along with a corresponding set-manipulated variable characteristic diagram. The set characteristic diagram describing the operating mode in this case involves, for example a set torque diagram, wherein the torque for the retarder is characterized by the braking torque. The individual torques over the entire operating region are thus denoted by Mₛₑₜ₁ to Mₛₑₜₙ. A corresponding manipulated variable Y, preferably in the form of a regulating pressure p_{Y} in the case of a hydrodynamic component, is assigned to each operating point, in particular set torque in the torque characteristic diagram. The set manipulated variable characteristic diagram for p_{Yset} that results therefrom is thus comprised of a plurality of individual manipulated variables p_{Yset1} to p_{Ysetn}. Preferably, the correlation of one with respect to another is provided via an rpm n of rotor R. The set torque characteristic diagram for Mₛₑₜ₁ to Mₛₑₜₙ is thus stored in an rpm/torque diagram. The individual characteristic diagram can be pre-given by a plurality of individual characteristic curves. The correlation preferably is provided by means of the rpm n at the rotor blade wheel of the hydrodynamic retarder. These two characteristic diagrams—the characteristic diagram for the set torques Mₛₑₜ and the characteristic diagram for the set manipulated variables p_{Yset}—thus form the initial base. During the braking process, in particular, the adjusting of a specific braking torque, the current characteristic diagram for the actual torque M_{actual} is determined, wherein a plurality of individual characteristic torque values M_{actual1} to M_{actualn} are determined, which map the individual operating points in the characteristic diagram for torque, for example, with respect to the rpm at the rotor blade wheel. Based on a comparison of the determined actual value, in the case shown of the torque M_{actual} with the set value Mₛₑₜ in the respective operating point, it is determined whether this corresponds to the desired set values corresponding to the set torque characteristic diagram. If the comparison shows that the set value Mₛₑₜ is exceeded for a specific operating point through M_{actual-i}, the manipulated variable is correspondingly adapted, reduced, for example, in the case shown, while when it is not reached, a change in the manipulated variable Yₛₑₜₙ ensues in the direction of an increase. In this respect, the manipulated variable Y, in the case shown p_{Yset}, can only be changed by addition or subtraction of a correction value, which is fixed in advance, freely defined, or can be determined. Another possibility corresponding to the embodiment according to FIG. 1 consists of producing here a functional relationship, in particular, between individual operating points (n_{actual-n}, M_{actual-n}) to be triggered for theoretically the same points in the set characteristic diagram, as well as changes in the manipulated variables p_{Yset}. There is considered, for example, for a specific operating point, which is characterized by a specific torque M_{actual-n} and can be adjusted by means of the manipulated variable p_{Ysetn}, the sequentially determined values upon repeated runs through the entire operating range for two identical operating points (n_{actual-n}, M_{actual-n}). In this way, there results the new manipulated variable p_{Ysetnew} to be used, from the product of the currently applied regulating pressure p_{Ysetn-(i-1)}, which corresponds to its pre-given set value p_{Yset} from the last adjustment of the same operating point (n_{actual-n}, M_{actual-n}), and the quotient from the current torque M_{actual-n(i-1)} from the last determination at the same operating point. Then, if the necessary accuracy has still not been reached, the correction is carried out again, i.e., repeated during the next runs through the operating point n. n thus characterizes a concrete operating point; i illustrates the number of the repeated adjustment of the operating point n. However, if the existing actual torque, M_{actual-ni} then lies in the tolerance region, the value for the manipulated variable p_{Yset-ni} used for this can be read in for this operating point n. The latter will then become p_{Ysetnew}. Preferably, a plurality of such iteration steps continually occur. In this way, this iteration will always be carried out relative to the operating point for each operating point n. This means that, for example, assuming a specific filling level, in the case of a specific rpm n₂ as a set value for the manipulated variable p_{Yset} at rpm n₂, and the torque Mₛₑₜ to be adjusted at n₂ is applied and the current torque M_{actual2} at n₂ is determined. If M_{actual2} deviates from the theoretically real set value Mₛₑₜ₂ to be adjusted at the same rpm n₂,

the correction of the manipulated variable p_{Yset2} results for the specific rpm n₂ and the torque Mₛₑₜ₂ for rpm n₂. Therefore, the set value for the manipulated variable p_{Yset2} is newly determined, by determining it from the product of p_{Yactual2} at rpm n₂ and the quotient from the current actual torque M_{actual2} at rpm n₂ and the last measurement M_{actual2-(1)} for rpm n₂. Then, if the necessary accuracy is achieved, this new set value can be read in as a fixed pre-given set value for the specific operating point n.

FIGS. 3a to 3c, which are based on different characteristic curves, illustrate the application and the effect of the method according to the invention. Here, the set characteristic diagram for the hydrodynamic retarder, which is the basis for the final testing, is reproduced in FIG. 3a. It is obvious from this that two retarder characteristic curves are substantially different here and these describe the generation of a maximum braking torque Mᵣₑₜ₋ₘₐₓ and a minimum braking torque Mᵣₑₜ₋ₘᵢₙ. This is also always dependent on the filling level FL of the hydrodynamic retarder or also on the desired braking step that has been input, so that in addition to the two different characteristic curves shown here, a plurality of such characteristic curves can also be given in advance. Each of these characteristic curves, which are denoted here as Mᵣₑₜ₋ₘₐₓ and Mᵣₑₜ₋ₘᵢₙ, is assigned a corresponding characteristic curve for the manipulated variables, and these two curves are designated p_{Ymax} and p_{Ymin}, respectively. The characteristic curves are reproduced in the so-called rpm/torque characteristic diagram (n/M diagram). The rpm n is described, for example, by the rpm of the retarder, in particular the rotor blade wheel R.

In comparison to this, FIG. 3b discloses the real actual characteristic diagram, as it results when the manipulated variable p_{Yset} is applied to the individual operating points. It can be recognized from this that there are, however, considerable deviations from the so-called set characteristic curves in specific regions of each individual actual characteristic curve. The correction is made by adapting the manipulated variable p_{Yset}, and in the concrete case here, both the manipulated variables, p_{Ymax} and p_{Ymin}, whereby the correction is carried out for each individual operating point. This applies analogously also to the minimum braking torque Mᵣₑₜ₋ₘᵢₙ that can be generated by the retarder.

The corrected manipulated variables p_{Yset} for the individual operating points n are newly read in, at least into a writable and readable memory. This memory can be attached to the hydrodynamic component 1, in particular, to the hydrodynamic retarder, for example, accommodated in the housing. It is also conceivable to read in the corrected set characteristic diagram p_{Yset} resulting from a plurality of these individual set values for manipulated variables into the control device 8 assigned to the hydrodynamic component 1, in particular, to the hydrodynamic retarder.

The embodiments presented in FIGS. 1 to 3 also apply analogously to other hydrodynamic components, hydrodynamic couplings or converters. In the first case, the component comprises a primary impeller and a secondary impeller, which together form a working chamber that can be filled with working medium. In the second case, at least one guide wheel is additionally provided. Also in this case, the transmissible power, in particular, the transmissible torque is optimized by adapting the manipulated variable, particularly the regulating pressure or the filling level.

The solution according to the invention is not limited to the possibility of the change in the manipulated variable p_{Yset} that is described here. It is conceivable, as has already been stated, to employ a change in steps by a specific pre-defined or pre-given correction value. This correction value can be calculated or else it can be freely established. This is particularly also associated with the interval in which such corrections will result. The correction can be provided by sequential runs through the specific operating point or else only by every i^{th} adjustment of the operating point n.

### LIST OF REFERENCE NUMBERS

1 Vehicle
2 Drive train
3 Driving machine
4 Wheel
5 Braking device
6 Supply system for working medium
7 Working chamber
8 Inlet
9 Outlet
10 Control device
11 Control device
12 Memory*
13 Memory
14 Device for advance setting of a driver's wish after deceleration of the vehicle
15 Recording device
16 Comparison device
17 Set value correction device
18 Recording device

1-8. (canceled)

9. A method for optimizing the operating mode of a hydrodynamic component which is integrated in a drive train of a vehicle, comprising:
filing a set characteristic curve or a set characteristic diagram for the hydrodynamic component in a memory storage unit;
assigning a set manipulated variable to each operating point of the set characteristic curve or the set characteristic diagram;
actuating a regulatory device assigned to the hydrodynamic component containing the set manipulated variable assigned to the operating point to be adjusted as a function of an advance setting after a specific torque is transmitted;
determining a current actual value (n_{actual-n}; M_{actual-n}) of at least one variable characterizing at least indirectly an operating point (n_{actual-ni}; M_{actual-ni});
comparing the current actual value with a set value from the set characteristic diagram;
changing the current actual value when the current actual value deviates from the set value, the set manipulated variable being changed in order to influence at least indirectly the current actual value; and
storing a changed set manipulated variable (p_{Yset-new}) for the operating point as a new set manipulated variable, the new set manipulated variable for actuating the regulating device for a desired repeated adjustment of the operating point.

10. The method of claim 9, wherein said changing step comprises utilizing a correction value that is either pre-given or calculated.

11. The method of claim 10, wherein the correction value is a fixed value.

12. The method of claim 9, further comprising:
assigning a tolerance range to the set value; and
undertaking an adaptive change until the tolerance range is reached.

13. The method of claim 9, further comprising:
determining a magnitude of deviation of an adjusted actual value from the set value for each stored value of the set manipulated variable; and
storing the magnitude of deviation in the set characteristic diagram.

14. The method of claim 9, further comprising:
determining a temperature of a working medium or a variable characterizing the working medium for each stored value of the set manipulated variable; and
storing the temperature in the set characteristic diagram.

15. A method for utilizing available braking power in a vehicle with a drive train, said drive train comprising a driving machine and a hydrodynamic braking device with a regulating device, the method comprising:
filing a set characteristic curve or a set characteristic diagram for a retarder in a memory storage unit;
assigning a set manipulated variable to each one of a plurality of operating points of the set characteristic curve or the set characteristic device;
generating a specific braking torque or a desired deceleration, the specific braking torque or the desired deceleration actuating the regulating device containing the set manipulated variable as a function of an advance setting;
determining a current actual value of at least one variable characterizing at least indirectly a braking process and describing an operating point;
comparing the current actual value with a set value from the set characteristic diagram;
changing the set manipulated variable when the current actual value deviates from the set value in order to influence at least indirectly the current actual value; and
storing a changed set manipulated variable for the operating point as a new set manipulated variable, the new set manipulated variable for actuating a control device for a desired repeated adjustment of the operating point.

16. The method of claim 15, further comprising:
determining a variable for the braking process either continually via an rpm of a rotor blade or by an element coupled with the rotor blade wheel, wherein if the actual value deviates from the set value, adapting a control pressure to change a filling level in a working chamber of the retarder.
